(19) United States
(12) Patent Application Publication
(10) Pub. No.: US 2010/0101926 A1
(43) Pub. Date: Apr. 29, 2010

(54) SAFETY MECHANISM FOR A POWER PATH

(76) Inventor: Loao Wang, Taiping (TW)

Correspondence Address: Loao Wang, 13F, No. 23, Jiun-Ho St., Beitun District, Taichung, 406, TW

(21) Appl. No.: 12/259,302

(22) Filed: Oct. 28, 2008

(51) Int. Cl. H01H 1/38

(52) U.S. Cl. 200/506

(57) ABSTRACT

A safety mechanism for a power path uses a mechanical structure for disconnecting a power path and providing a safety measure for electric equipments. The safety mechanism includes a casing, two conducting copper plates, a slide base, two rotating blocks, two sets of resilient elements and an insert pin. When the power path is connected, the insert pin must be always situated in a pin hole of the casing and inserted completely for contacting and conducting the corresponding pins of the two conducting copper plates. If it is necessary to disconnect a circuit in an emergency situation, users simply pull out the insert pin to rotate the rotating block accordingly, and allow the rotating block to synchronously drive the slide base to displace, such that the corresponding pins of the two conducting copper plates are forced to separate to form a disconnected circuit status.

### BACKGROUND OF THE INVENTION

1. Fields of the Invention

The present invention relates to a safety mechanism for a power path, and a safety mechanism that can be used directly as a power safety plug or installed between power paths of any one of the electric equipments, such that its mechanical breaker mechanism can be used to achieve the safety effect.

2. Description of the Related Art

In present electric equipments, a power cord or its connector is generally used for connecting a power source. In other words, if the connector is inserted into a power socket, an electric power is passed into a control circuit of an electric equipment and the electric equipment enters into a standby mode. Users simply press a start key (or button) of a control circuit (or a circuit board) to start the basic operation of the electric equipment, and it is an operating and controlling mode of a conventional basic application. In case a special or emergency situation occurs and it is necessary to disconnect the power of the electric equipment immediately, users usually have no other choice except trying to press a stop key (or button) of the control circuit or unplug a power connector.

If the control circuit (or circuit board) fails, users cannot disconnect the power by pressing the stop key (or button), and thus a master power switch must be found immediately to disconnect the supply of all power, or else a serious consequence will result. Obviously, the safety of traditional electric equipments taken into consideration for its design is insufficient.

At present, some manufacturers install an emergency breaking switch (such as a safety insert pin used for an electric treadmill or a general electronic breaker) in the control circuit of a certain electric equipment, such that the emergency breaking switch can be pressed (or the safety insert pin can be unplugged) to stop the operation of the electric equipment immediately, so as to achieve the expected safety effect.

In case the emergency breaking switch fails, the original expected function will be lost, and user [symbol] s safety will be jeopardized seriously. With the foregoing conventional design, the electric equipment is still in the standby mode of supplying power to the electric equipment and its control circuit, after the emergency breaking switch is pressed, and thus the power of the electric equipment has not been disconnected completely, and there is a risk for the electric equipment to continue its operation, and the aforementioned problem has not been overcome completely yet. Although the probability for the occurrence of the breakdown is not too high, yet manufacturer cannot afford to take the chance or allow a fixed power to be supplied to electric equipments and their control circuit. Obviously, supplying electric power in a fixed mode is a serious mistake.

### SUMMARY OF THE INVENTION

In view of the foregoing shortcomings of the prior art, the inventor of the present invention based on years of experience in the related industry to conduct extensive researches and experiments, and finally developed a safety mechanism to overcome the shortcomings of the prior art.

It is a primary object of the invention to provide a safety mechanism using a mechanical structure to interrupt the power for a power path, so as to stop supplying power to the electric equipment and its control circuit and assure the safety of using the electric equipment.

According to the invention, a safety mechanism for a power path uses a mechanical structure for disconnecting a power path and providing a safety measure for electric equipments. The safety mechanism includes a casing, two conducting copper plates, a slide base, two rotating blocks, two sets of resilient elements and an insert pin. When the power path is connected, the insert pin must be always situated in a pin hole of the casing and inserted completely for contacting and conducting the corresponding pins of the two conducting copper plates. If it is necessary to disconnect a circuit in an emergency situation, users simply pull out the insert pin to rotate the rotating block accordingly, and allow the rotating block to synchronously drive the slide base to displace, such that the corresponding pins of the two conducting copper plates are forced to separate to form a disconnected circuit status.

### BRIEF DESCRIPTION OF THE DRAWINGS

The accomplishment of this and other objects of the invention will become apparent from the following description and its accompanying drawings of which:

FIG. 1 is a perspective view of a preferred embodiment of the present invention;

FIG. 2 is a cross-sectional view of a portion of FIG. 1;

FIG. 3 is a perspective view of a slide base of the present invention;

FIG. 4 is perspective view of a rotating block of the present invention;

FIG. 5 is a planar view of an assembly of FIG. 1;

FIG. 6 is a schematic view of positions of related partial components of FIG. 5;

FIG. 7 is a schematic view of operations of FIG. 5

FIG. 8 is a schematic view of positions of related partial components of FIG. 7;

FIG. 9 is a schematic view of continuous operations of FIG. 5; and

FIG. 10 is a schematic view of another preferred embodiment of the present invention.

### DETAILED DESCRIPTION OF THE PREFERRED EMBODIMENT

The present invention will now be described in more detail hereinafter with reference to the accompanying drawings that show various embodiments of the invention.

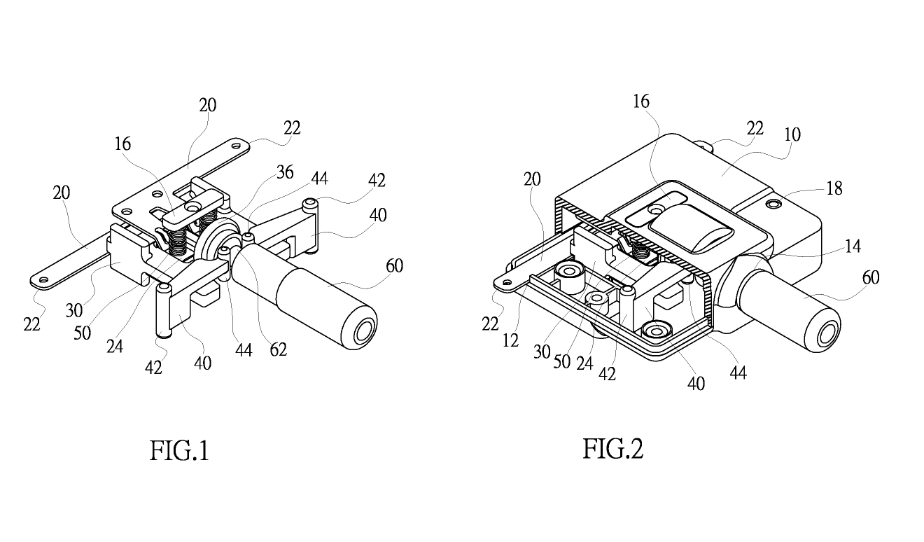

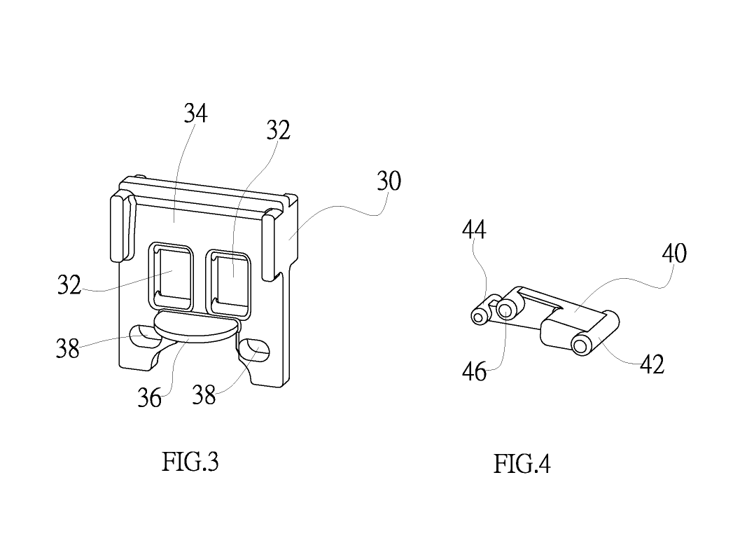

With reference to FIGS. 1 to 4, the invention comprises:

a casing 10, for accommodating components, and having an outlet hole 12 of a connecting end portion 22 of a conducting copper plate 20, a pin hole 14, a positioning board 16 of a resilient element 50 and a pivoting portion 18 of a rotating block 40;

two conducting copper plates 20, each having a connecting end portion 22 for connecting a power cable (not shown in the figure) or being used directly as a power connector, and a corresponding pin 24 disposed on another end of the conducting copper plate 20;

a slide base 30, disposed between the two conducting copper plates 20, and made of an insulating material, and having two hollow grooves 32 disposed proximate to the center of the slide base 30, and a side of the hollow groove 32 being an insulating insolated portion 34, and another side of the hollow groove 32 having a stop surface 36, and an insert hole 38 being disposed separately on both sides of the stop surface 36;

two rotating blocks 40, pivotally coupled to a pivoting portion 18 of a casing 10 by using pivotal pillar 42, and another end of the rotating block 40 having a latch pillar 44 and a linking pillar 46, such that the linking pillar 46 is passed into the insert hole 38 of the slide base 30 to constitute a linking assembly status;

two sets of resilient elements 50, installed between the casing 10 and corresponding pin 24 of the conducting copper plate 20 by using the action of the positioning board 16 of the casing 10; and

an insert pin 60, inserted and passed into the pin hole 14 of the casing 10, and having a circular groove 62 disposed proximate to the front, for latching the latch pillar 44 of the rotating block.

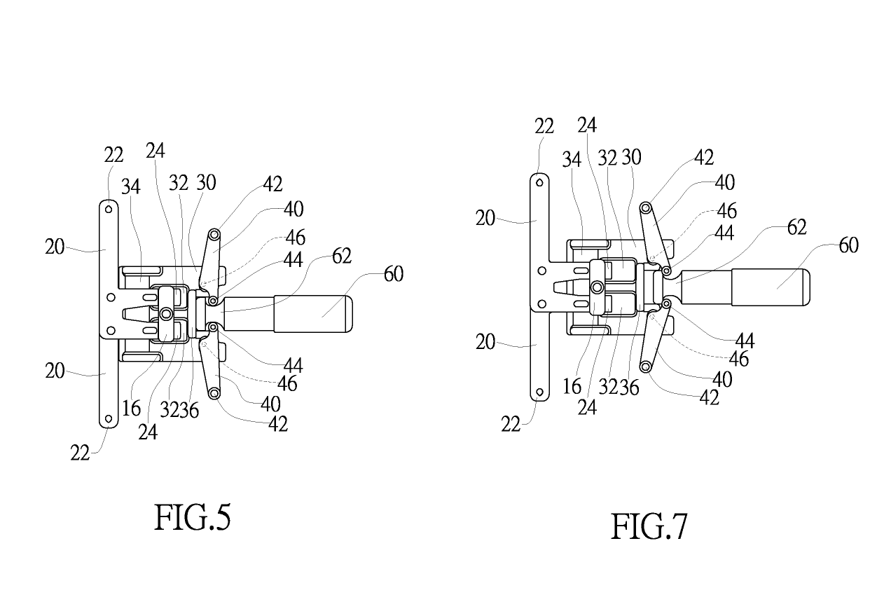

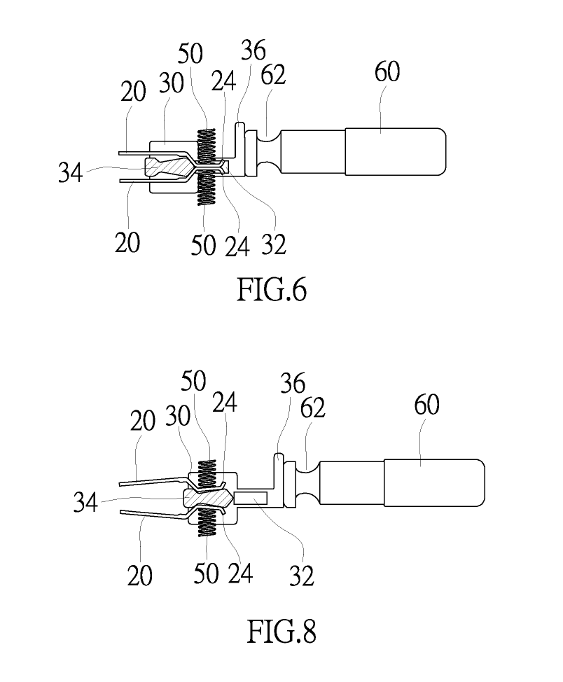

With the assembly of the foregoing components, the power circuit is in a connected status as shown in FIGS. 5 and 6. Now, the insert pin 60 is situated in the pin hole 14 of the casing 10 and inserted completely, and the slide base 30 is retracted since the stop surface 36 is pushed by the insert pin 60, so that the corresponding pins 24 of the two conducting copper plates 20 are pressed by the resilient element 50, and the corresponding pins 24 are contacted and conducted through the hollow groove 32 of the slide base 30.

In FIGS. 7 and 8, the power circuit is disconnected. If the insert pin 60 is pulled slightly by an external force to move, then the latch pillar 44 of the rotating block 40 situated at the circular groove 62 of the insert pin 60 will be forced to rotate. Now, the linking pillar 46 is driven. By the linking relation with the insert hole 38 of the slide base 30, the slide base 30 is driven immediately to shift to an opposite direction, so that the insulating insolated portion 34 of the slide base 30 forces the corresponding pins 24 of the two conducting copper plates 20 to be separated to constitute a disconnected circuit status.

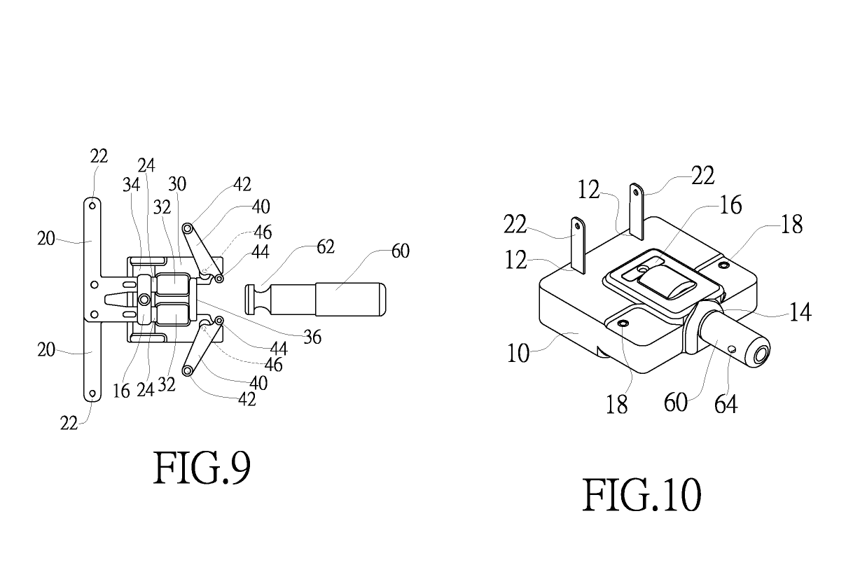

With reference to FIG. 9 for a schematic view of a continuous operation of the power circuit in a disconnected circuit status, the rotating block 40 will be blocked by the casing 10 and stopped rotating or moving if the insert pin 60 is pulled out completely out from the pin hole 14 of the casing 10, but users can remove the insert pin 60 to make sure that the power circuit is completely disconnected. If it is necessary to resume the connection of the power circuit, the insert pin 60 is inserted back into the original position (indicated in FIGS. 5 and 6), such that the rotating block 40 and the slide base 30 resume their original positions to achieve the expected connection effect.

Similarly, the latch pillar 44 is latched into the circular groove 62 in the process of reinstalling the insert pin 60, so that the insert pin 60 is latched and fixed without a risk of falling off unexpectedly.

With reference to FIG. 10, the connecting end portion 22 of the conducting copper plate 20 of the present invention is designed in the form of an electric connector, and a penetrating hole 64 is disposed at an end of the insert pin 60 for connecting an object such as a string (not shown in the figure) that can be pulled and controlled at a remote end, so as to expand the scope of applicability and practicability.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A safety mechanism for a power path, comprising:
a) a casing, for accommodating all components, and having an outlet hole of a connecting end portion of a conducting copper plate, a pin hole, a positioning board of a resilient element and a pivoting portion of a rotating block;
b) two conducting copper plates, having the connecting end portion at one end of each conducting copper plate, and a corresponding pin disposed at another end of the conducting copper plate;
c) a slide base, disposed between two conducting copper plates, and made of an insulating material, and having two hollow grooves disposed proximate to the center of the slide base, and an insulating insolated portion being disposed on a side of the hollow groove, and a stop surface being disposed on another side of the hollow groove, and an insert hole being disposed separately on both sides of the stop surface;
d) two rotating blocks, pivotally coupled to casing pivoting portion through a pivotal pillar, and another end of each rotating block having a latch pillar and a linking pillar, such that the linking pillar is passed precisely through an insert hole of the slide base to constitute a link assembly status;
e) two sets of resilient elements, installed between the casing and corresponding pins of the conducting copper plate by using the action of the casing positioning board; and
f) an insert pin, inserted and passed through the pin hole of the casing, and having a circular concave groove disposed proximate to the front, and provided for latching the latch pillar of the rotating block precisely;
whereby, in the assembly of the aforementioned elements, the insert pin must be always situated in the pin hole of the casing and inserted into the pin hole completely for the corresponding pins of the two conducting copper plates are contacted and conducted when the power path is electrically conducted, and it is necessary to pull out the insert pin and let the rotating block rotate if it is necessary to disconnect the circuit, and the rotating block synchronously drives the slide base to displace, so that the corresponding pins of the two conducting copper plates are forced to separate and form a disconnected circuit status.

2. The safety mechanism for a power path as recited in claim 1, wherein the insert pin includes a penetrating hole disposed at an end of the insert pin.
